(19) United States
(12) Patent Application Publication
(10) Pub. No.: US 2011/0280431 A1
(43) Pub. Date: Nov. 17, 2011

(54) KEYCHAIN SPEAKER

(76) Inventor: Shu Ming HO, Fullerton, CA (US)

(21) Appl. No.: 12/781,452

(22) Filed: May 17, 2010

(51) Int. Cl. H04R 1/02

(52) U.S. Cl. 381/386

(57) ABSTRACT

A speaker has a speaker body of a generally cubical shape of a small keychain size of under eight cubic inches in volume. An upper rim is formed on the speaker body which has an upper rim inside surface sized to receive a standard sized plastic bottle. Internal speaker components are housed within the speaker body. An audio input provides audio signal to the speaker. A plurality of threads have small annular threading grooves and protrusions and are sized for engaging with a standard sized plastic bottle. The plurality of threads are circularly deposed and are within the bounds of the upper rim inside surface. The speaker has a front flat sidewall and a rear flat sidewall. A medium annular rim is located within the bounds of the upper rim inside surface. The medium annular rim is sized to engage with a standard sized plastic bottle.

### FIELD OF THE INVENTION

The present invention is in the field of small speaker systems, small enough to fit on a keychain.

### DISCUSSION OF RELATED ART

A number of speaker systems have been made in the past having stereo functionality, stereo with subwoofer and surround sound 5.1 functionality. Many of the more sophisticated speaker systems are mounted in a home, such as in a wall of a home on a semi permanent basis. With the advent of personal music devices, mobile speaker systems became much more common. Some of the portable speaker systems then became small enough to fit in a pocket. Smaller than the pocket size is the keychain size. More recently, flash memory has decreased the size of music storage devices, making such devices small enough to fit on a keychain. Unfortunately, very small speaker systems have not been implemented on a keychain sized basis.

Miniaturized speaker components are available, such as shown in Loya U.S. Pat. No. 5,168,527 issued Dec. 1, 1992 for a miniature speaker variable standoff mount, the disclosure of which is incorporated herein by reference shows a miniature speaker mount that is connectable to a printed circuit board. A variety of headphones shows that miniaturization has been possible for decades, such as headphones integrated with eyeglasses as seen in Weyer U.S. Pat. No. 4,902,120 issued Feb. 20, 1990 for eyeglass headphones, the disclosure of which is incorporated herein by reference.

### SUMMARY OF THE INVENTION

A speaker has a speaker body of a generally cubical shape of a small keychain size of under eight cubic inches in volume. An upper rim is formed on the speaker body which has an upper rim inside surface sized to receive a standard sized plastic bottle. Internal speaker components are housed within the speaker body. An audio input provides audio signal to the speaker. A plurality of threads have small annular threading grooves and protrusions and are sized for engaging with a standard sized plastic bottle. The plurality of threads are circularly deposed and are within the bounds of the upper rim inside surface. The speaker has a front flat sidewall and a rear flat sidewall. A medium annular rim is located within the bounds of the upper rim inside surface. The medium annular rim is sized to engage with a standard sized plastic bottle.

A plurality of threads have small annular threading grooves and protrusions, and the plurality of threads are sized for engaging with a standard sized plastic bottle. The plurality of threads are circularly deposed and are within the bounds of the upper rim inside surface. A top plate has a plurality of small openings for sound passage, and the top plate is located on a top portion of the speaker body. The top plate can be oval shaped to be offset so as not to cover the entire top opening. The medium annular rim surrounds the speaker body top plate, and the speaker body top plate is offset to provide a top plate lower opening and a top plate upper opening, so that sound is directed out of the top plate lower opening and the top plate upper opening when the speaker is activated.

The speaker is housed in a speaker body that is keychain sized and capable of being connected to a keychain. If connected to a keychain, a keychain connection member can be formed as a part of the speaker housing and having an opening receiving a small ring. The small ring may connect to a first link, which is connected to a second link, which is connected to a third link which is connected to a fourth link, which is connected to a fifth link. The interconnected chain of links terminating at the fifth link is connected to a large ring which can connect to keys. The keychain connection member can be located on a top corner of the speaker body, and the keychain connection member can also be located on a lower corner of the speaker body. The keychain connection member can be formed as a vertical connection tab, instead of horizontally oriented or disposed. The vertical connection tab has an opening for connection with a small ring.

The speaker body can be formed as a generally cubical shape having an upper rim and a lower rim. The upper rim has an inside surface which is raised above a flat top portion of the speaker body. The upper rim inside surface can engage with a bottle rim of a large water bottle. The bottle rim is below the neck ring and is sized to be fitted to the upper rim inside surface. When the speaker body is formed as a generally cubical shape having an upper rim which also follows the same general cubical shape such that the upper rim has a square shape, it is preferred that the upper rim inside surface engage with the bottle rim at a total of four locations, namely a front, back, left, right location on the bottle rim. The bottom surface of the bottle rim rests on the top of the speaker body.

The speaker body includes internal speaker components such as commonly known in the art. Such internal speaker components produced sound as vibrations which pass through openings in a top portion of the housing. The sounds pass through the bottle for amplification. The bottle is preferably a recycled plastic water bottle with an end cut. The upper rim inside surface is preferably sized for receiving a large water bottle.

A power switch can control power and a USB connection can be located on the speaker body. The USB connection can be any other data and power connection. An auxiliary jack can receive audio signals from a stereo jack for example. The stereo jack can input via the auxiliary jack which outputs sound by the internal speaker components. The stereo jack can be connected to an MP3 player. The internal components are preferably of stereo quality.

A speaker body top can have a plurality of small round openings for releasing the sound through a top plate, and/or the speaker body top can be offset. In offset connection mode, the speaker body top has a medium annular portion surrounding a speaker body top plate. The speaker body top plate if offset forms a top plate lower opening and a top plate upper opening. Sound can be directed out of the openings. The offsetting can be fixed as an oval. The sound coming from the top plate lower opening can be of a first channel and the sound coming from the top plate upper opening can be of a second channel to provide stereo effect.

In addition to receiving a large size water bottle, the present invention also may receive a medium-size bottle or intermediate bottle. The speaker body which acts as a housing may optionally include a medium annular rim having an inside surface facing inward for engaging a lower outside surface of a water bottle rim. The intermediate bottle may have a lower service resting on the medium annular face of the medium annular rim. The medium annular face is bounded between the medium annular rim and the medium annular inside edge.

In addition to receiving a medium-size water bottle, the present invention may also receive a small size water bottle. The medium annular inside edge can also be a small annular inside edge that engages to the water bottle in a threaded fashion. The water bottle may thread to a plurality of small annular threading groove and a plurality of small annular threading protrusions. The threading of the internal surfaces may require removal of the top plate while the small water bottle is in use. Alternatively, the top plate can be made in a spring loaded fashion so that it is depressed when the small water bottle presses upon it.

Thus, the present invention provides three connection methods. In the first example, a large plastic water bottle, or a plastic beverage bottle can be held at four locations on the upper rim inside surface. In the second example, the medium bottle can be retained against the medium annular rim. In the third example, the small bottle can be threaded and received into a plurality of threads having small annular threading grooves and small annular threading protrusions.

During use, the preferred usage of the invention is to carry around the keychain speaker with a personal media player such as a flash memory storage MP3 media player. The user can then take a ubiquitous plastic beverage bottle and connect the bottle to one of the three connection areas on the top of the housing. The user preferably cuts an opening or an end off of the plastic beverage bottle for directing sound according to user preference. A user can cut openings on a side of the water bottle, or a user can cut the water bottle in half. As the plastic bottle is inexpensive, the user can experiment with different configurations and designs. Optionally, a user can add stickers or other decoration to the plastic beverage bottle.

### BRIEF DESCRIPTION OF THE DRAWINGS

FIG. 1 is a perspective view of the present invention receiving a large bottle.

FIG. 2 is a diagram of the present invention with the hardtop.

FIG. 3 is a diagram of the present invention with the small opening top.

FIG. 4 is a perspective view of the present invention receiving a midsize bottle.

FIG. 5 is a perspective view of the present invention receiving a small sized bottle.

The following call out list of elements can be useful in referencing the drawings.
21 Keychain Connection Member
22 Small Ring
23 First Link
24 Second Link
25 Third Link
26 Fourth Link
27 Fifth Link
28 Large Ring
30 Speaker Body
31 Lower Rim
32 Upper Rim
33 Inside Surface Of Upper Rim
34 USB Connection
35 Power Button
36 Auxiliary Jack
37 Battery Tray
42 Neck Ring
43 Bottle Rim
52 Speaker Body Top
88 Vertical Connection Tab
111 Large Bottle
112 Intermediate Bottle
113 Small Bottle
132 Top Plate
134 Medium Annular Portion
135 Speaker Body Top Plate
136 Top Plate Lower Opening
137 Top Plate Upper Opening
141 Medium Annular Rim
142 Medium Annular Face
143 Medium Annular Inside Edge
151 Small Annular Inside Edge
152 Small Annular Threading Groove
153 Small Annular Threading Protrusion

### DETAILED DESCRIPTION OF THE PREFERRED EMBODIMENT

The speaker is housed in a speaker body 30 that is keychain sized and capable of being connected to a keychain. The speaker body 30 is preferably smaller than two inches in height, width and length for a total volume of approximately 8 in.³. The speaker housing can be of a generally cubical shape and with gently curving edges.

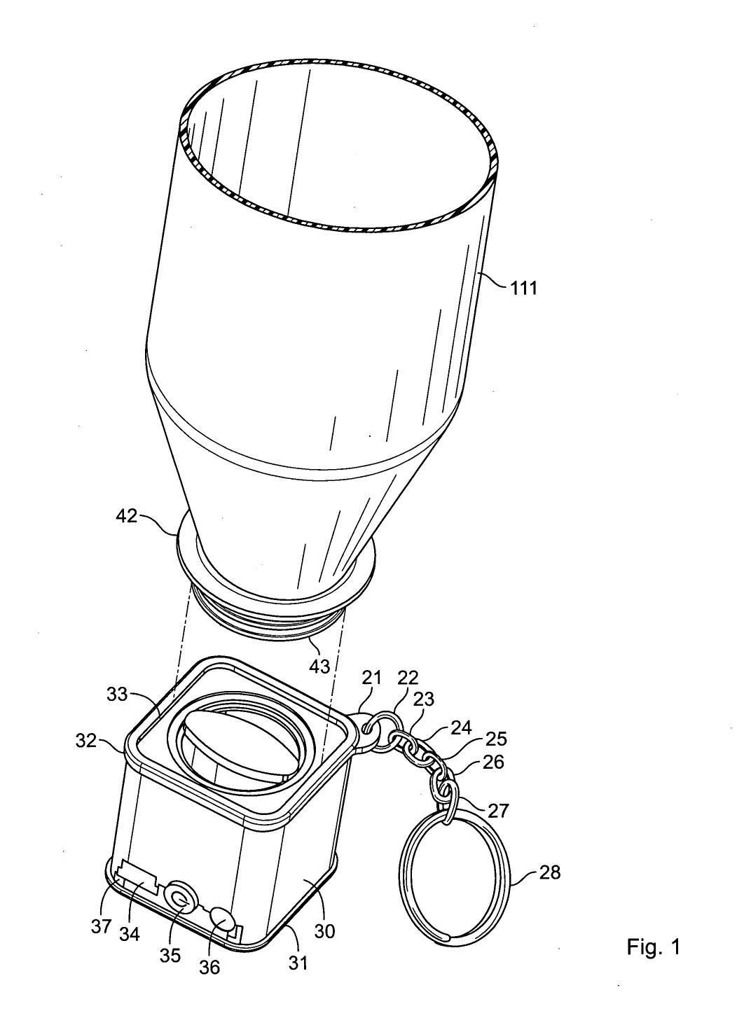

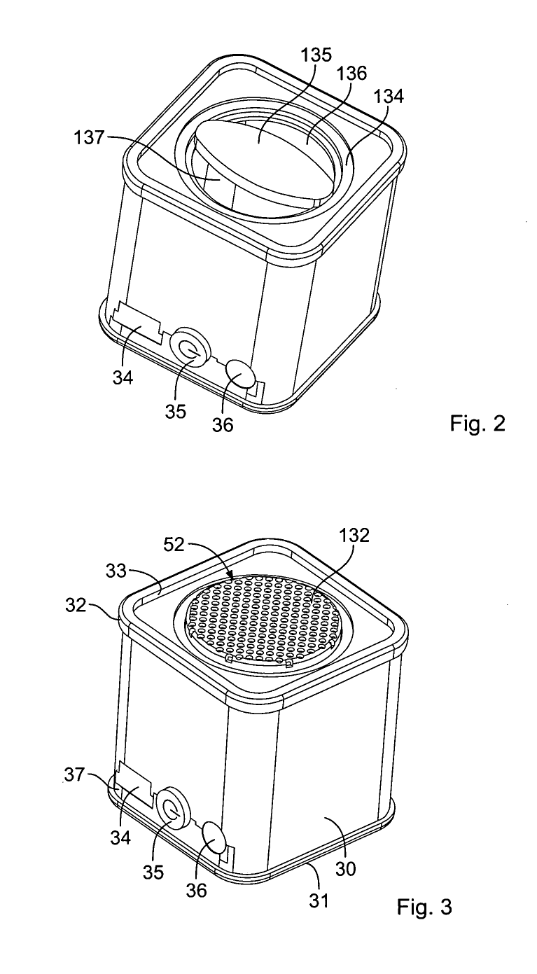

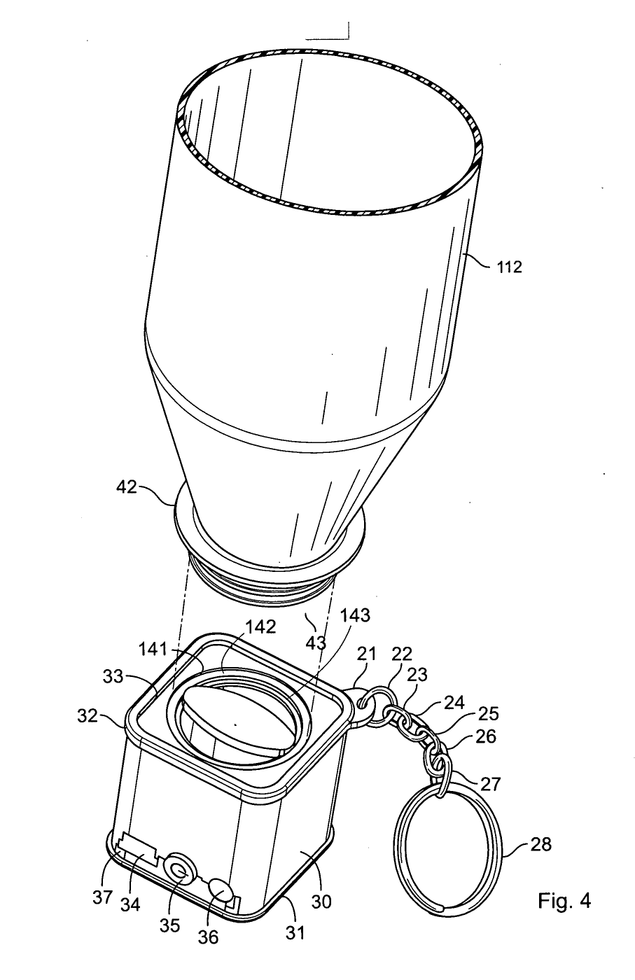

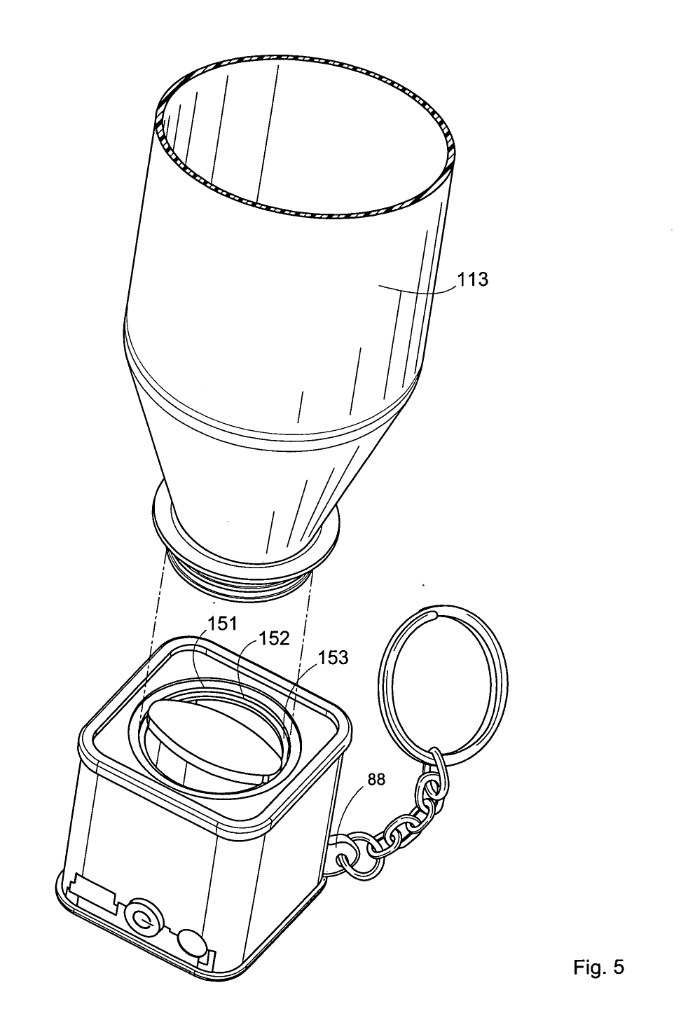

If connected to a keychain, a keychain connection member 21 can be formed as a part of the speaker housing 30 and having an opening receiving a small ring 22. The small ring 22 may connect to a first link 23, which is connected to a second link 24, which is connected to a third link 25 which is connected to a fourth link 26, which is connected to a fifth link 27. The interconnected chain of links terminating at the fifth link 27 is connected to a large ring 28 which can connect to keys. FIG. 1 shows the keychain connection member 21 located on a top corner of the speaker body, and the keychain connection member 21 can also be located on a lower corner of the speaker body. The keychain connection member can be formed as a vertical connection tab 88, instead of horizontally oriented or disposed, FIG. 5. The vertical connection tab has an opening for connection with a small ring 22.

The speaker body 30 can be formed as a generally cubical shape having an upper rim 32 and a lower rim 31. The upper rim has an inside surface 33 which is raised above a flat top portion of the speaker body 30. The upper rim inside surface 33 can engage with a bottle rim 43 of a large water bottle 111. The bottle rim 43 is below the neck ring 42 and is sized to be fitted to the upper rim inside surface 33. When the speaker body 30 is formed as a generally cubical shape having an upper rim 32 which also follows the same general cubical shape such that the upper rim has a square shape, it is preferred that the upper rim inside surface 33 engage with the bottle rim 43 at a total of four locations, namely a front, back, left, right location on the bottle rim 43. The bottom surface of the bottle rim 43 rests on the top of the speaker body 30. When the speaker body 30 is formed as a generally cubical shape, it has four vertical flat sidewall members, namely a front flat sidewall, a left flat side wall, a right flat sidewall, and a rear flat sidewall. At least a portion of a sidewall is flat.

The speaker body 30 includes internal speaker components such as commonly known in the art.

Such internal speaker components produced sound as vibrations which pass through openings in a top portion of the housing. The sounds pass through the bottle for amplification. The bottle is preferably a recycled plastic water bottle with an end cut, such as is shown in the figures. The upper rim inside surface is preferably sized for receiving a large water bottle. The speaker can be powered by batteries located in the batteries tray 37 which slides out for changing batteries in the housing. Alternatively, the speaker can be powered by a USB or by the signal through the stereo jack.

A power switch 35 can control power and a USB connection 34 can be located on the speaker body. The USB connection 34 can be any other data and power connection. An auxiliary jack 36 can receive audio signals from a stereo jack for example. The stereo jack can input via the auxiliary jack which outputs sound by the internal speaker components. The stereo jack can be connected to an MP3 player. The internal components are preferably of stereo quality.

A speaker body top 52 can have a plurality of small round openings for releasing the sound through a top plate 132, and/or the speaker body top 52 can be offset. In offset connection mode, the speaker body top 52 has a medium annular portion 134 surrounding a speaker body top plate 135. The speaker body top plate if offset forms a top plate lower opening 136 and a top plate upper opening 137. Sound can be directed out of the pair of openings which can be corresponding to stereo channels. The top plate lower opening and top plate upper opening can be formed as crescent shaped openings.

In addition to receiving a large size water bottle, the present invention also may receive a medium-size bottle or intermediate bottle 112. The speaker body 30 which acts as a housing may optionally include a medium annular rim 141 having an inside surface facing inward for engaging a lower outside surface of a water bottle rim. The intermediate bottle 112 may have a lower service resting on the medium annular face 142 of the medium annular rim 141. The medium annular face 142 is bounded between the medium annular rim 141 and the medium annular inside edge 143.

In addition to receiving a medium-size water bottle, the present invention may also receive a small size water bottle. The medium annular inside edge 143 can also be a small annular inside edge 151 that engages to the water bottle in a threaded fashion. The water bottle may thread to a plurality of small annular threading groove 152 and a plurality of small annular threading protrusions 153. The threading of the internal surfaces may require removal of the top plate 132 while the small water bottle is in use. Alternatively, the top plate 132 can be made in a spring loaded fashion so that it is depressed when the small water bottle presses upon it.

Thus, the present invention provides three connection methods all of which can be simultaneously present. In the first method, a large plastic water bottle, or a plastic beverage bottle can be held at four locations on the upper rim inside surface 33. In the second method, the medium bottle can be retained against the medium annular rim 141. In the third method, the small bottle can be threaded and received into a plurality of threads having small annular threading grooves 152 and small annular threading protrusions 153. Such connection methods can be friction fit, and the fit can be improved by forming grippy elastomeric engaging surfaces at fit interfaces.

During use, the preferred usage of the invention is to carry around the keychain speaker with a personal media player such as a flash memory storage MP3 media player. The user can then take a ubiquitous plastic beverage bottle and connect the bottle to one of the three connection areas on the top of the housing 30. The user preferably cuts an opening or an end off of the plastic beverage bottle for directing sound according to user preference. A user can cut openings on a side of the water bottle, or a user can cut the water bottle in half. As the plastic bottle is inexpensive, the user can experiment with different configurations and designs.

Optionally, a user can add stickers or other decoration to the plastic beverage bottle.

Although the invention has been disclosed in detail with reference only to the preferred embodiments, those skilled in the art will appreciate that various other embodiments can be provided without departing from the scope of the invention. Accordingly, the invention is defined only by the claims set forth below.

1. A speaker comprising:
a. a speaker body having a small keychain size;
b. an upper rim formed on the speaker body, wherein the upper rim has an upper rim inside surface sized to receive a standard sized plastic bottle;
c. internal speaker components housed within the speaker body; and
d. an audio input to the speaker body.

2. The speaker of claim 1, further comprising:
a. a plurality of threads having small annular threading grooves and protrusions, wherein the plurality of threads are sized for engaging with a standard sized plastic bottle, wherein the plurality of threads are circularly deposed and are within the bounds of the upper rim inside surface.

3. The speaker of claim 1, further comprising:
a. a front flat sidewall and a rear flat sidewall;
b. a medium annular rim located within the bounds of the upper rim inside surface, wherein the medium annular rim is sized to engage with a standard sized plastic bottle.

4. The speaker of claim 3, further comprising:
a. a plurality of threads having small annular threading grooves and protrusions, wherein the plurality of threads are sized for engaging with a standard sized plastic bottle, wherein the plurality of threads are circularly deposed and are within the bounds of the upper rim inside surface.

5. The speaker of claim 3, further comprising:
a. a top plate having a plurality of small openings for sound passage, wherein the top plate is located on a top portion of the speaker body.

6. The speaker of claim 3, wherein the top plate is offset and wherein the medium annular rim surrounds the speaker body top plate, wherein the speaker body top plate is offset to provide a top plate lower opening and a top plate upper opening, wherein sound is directed out of the top plate lower opening and the top plate upper opening when the speaker is activated.

7. The speaker of claim 3, wherein the top plate is oval shaped.

8. The speaker of claim 1, wherein the speaker body is less than eight cubic inches in volume.

9. The speaker of claim 8, further comprising:
a. a plurality of threads having small annular threading grooves and protrusions, wherein the plurality of threads are sized for engaging with a standard sized plastic bottle, wherein the plurality of threads are circularly deposed and are within the bounds of the upper rim inside surface.

10. The speaker of claim 8, further comprising:
a. a front flat sidewall and a rear flat sidewall;
b. a medium annular rim located within the bounds of the upper rim inside surface, wherein the medium annular rim is sized to engage with a standard sized plastic bottle.

11. The speaker of claim 10, further comprising:
a. a plurality of threads having small annular threading grooves and protrusions, wherein the plurality of threads are sized for engaging with a standard sized plastic bottle, wherein the plurality of threads are circularly deposed and are within the bounds of the upper rim inside surface.

12. The speaker of claim 10, further comprising:
a. a top plate having a plurality of small openings for sound passage, wherein the top plate is located on a top portion of the speaker body.

13. The speaker of claim 12, wherein the top plate is offset and wherein the medium annular rim surrounds the speaker body top plate, wherein the speaker body top plate is offset to provide a top plate lower opening and a top plate upper opening, wherein sound is directed out of the top plate lower opening and the top plate upper opening when the speaker is activated.

14. The speaker of claim 12, wherein the top plate is oval shaped.

15. The speaker of claim 1, wherein the speaker body has a generally cubical shape, and wherein the speaker body is less than eight cubic inches in volume.

16. The speaker of claim 15, further comprising:
a. a plurality of threads having small annular threading grooves and protrusions, wherein the plurality of threads are sized for engaging with a standard sized plastic bottle, wherein the plurality of threads are circularly deposed and are within the bounds of the upper rim inside surface.

17. The speaker of claim 15, further comprising:
a. a front flat sidewall and a rear flat sidewall;
b. a medium annular rim located within the bounds of the upper rim inside surface, wherein the medium annular rim is sized to engage with a standard sized plastic bottle.

18. The speaker of claim 15, further comprising:
a. a plurality of threads having small annular threading grooves and protrusions, wherein the plurality of threads are sized for engaging with a standard sized plastic bottle, wherein the plurality of threads are circularly deposed and are within the bounds of the upper rim inside surface.

19. The speaker of claim 15, further comprising:
a. a top plate having a plurality of small openings for sound passage, wherein the top plate is located on a top portion of the speaker body.
